(19) United States
(12) Patent Application Publication
(10) Pub. No.: US 2026/0244444 A1
(43) Pub. Date: Aug. 20, 2026

(54) NETWORK SCHEDULING METHOD AND APPARATUS

(71) Applicant: Oriole Networks Ltd., London (GB)

(72) Inventor: Joshua Benjamin, London (GB)

(73) Assignee: Oriole Networks Ltd., London (GB)

(21) Appl. No.: 19/538,797

(22) Filed: Feb. 12, 2026

(30) Foreign Application Priority Data
Feb. 14, 2025 (EP) EP25158124.5

(51) Int. Cl. G06F 9/30

(52) U.S. Cl. CPC G06F 9/30072; G06F 9/30014; G06F 9/30018; G06F 9/30032; G06F 9/30036; G06F 9/30038

(57) ABSTRACT

A network scheduling method for allocating network resources in a network comprising a plurality of nodes. The method comprises: obtaining a binary request vector representative of a plurality of requests for network resources, each request being from a requesting node of the plurality of nodes for a network resource, the binary request vector comprising n elements, wherein n is the number of requesting nodes in the plurality of nodes; generating a seed vector comprising n elements, the seed vector being a one-hot binary vector that indicates the requesting node that currently holds priority; and computing a grant vector based on the binary request vector and the seed vector, wherein the grant vector provides an indication of grant to one of the plurality of requests.

### FIELD OF THE INVENTION

The present disclosure relates to a method and apparatus for network scheduling, in particular to allocate network resources for communication between nodes connected in a network.

### BACKGROUND

Recent growth in volume of on-demand data has been exponential. Much of the data is stored/processed in and accessed from data centres in which large numbers of servers are connected in a network. It is a continual challenge to scale these and other networks and still handle the network traffic, while managing cost, power consumption, latency and so forth. A fundamental challenge is how to schedule and re-configure network resources (switches, buffers, paths, etc.) in nanoseconds in order to transfer information data from any to any network termination point in a deterministic way. Processing the traffic demands in order to allocate network resources, such as connection bandwidth and switch port in electronic networks, and path, timeslot and wavelength in optical networks, is a computationally hard problem, and needs to be handled on nanosecond timescales.

In such networks, scheduling units play a pivotal role in determining how data packets are prioritized and routed through the network. Central to the operation of a scheduling unit is the arbiter, fairly allocates network resources based on predefined rules or algorithms.

High-performance FPGAs are commonly used in network accelerator cards primarily for their programmability and high speed I/O interfacing capability that enables full stack solutions in data centres and high-performance computer (HPC) clusters, such as in AI/ML systems. Arbiters are building blocks that enable high-speed decision making in such environments. However, implementing arbiters using gates on an FPGA introduces several challenges that impact system performance and scalability. In particular, resources are typically limited by the choice of device for an FPGA, and implementing arbiters becomes challenging when scale increases.

The embodiments of the present disclosure are devised in view of the above problems.

### SUMMARY

In accordance with a first aspect of the present disclosure, there is provided network scheduling method for allocating network resources in a network comprising a plurality of nodes, the method comprising:
obtaining a binary request vector representative of a plurality of requests for network resources, each request being from a requesting node of the plurality of nodes for a network resource to access a destination node of the plurality of nodes, the binary request vector comprising n elements, wherein n is the number of nodes in the plurality of requesting nodes;
generating a seed vector comprising n elements, the seed vector being a one-hot binary vector that indicates the requesting node that currently holds priority; and
computing a grant vector based on the binary request vector and the seed vector, wherein the grant vector provides an indication of grant to one of the plurality of requests.

The present disclosure provides a method that can be performed by a network component in a network, such as an arbiter in a data scheduling unit. By computing a grant vector using the binary request vector and the seed vector, this methodology allows the arbiter to ensure that each requesting node requesting a network resource is fairly allocated the requested network resource using logical operations that are easily performed by a standard component used to implement the arbiter. For example, the methodology can be implemented using logic circuitry present in a device such as a field-programmable gate array (FGPA). Furthermore, the grant vector can be computed using well-researched components, such as adders. Advantageously, clock speed can be increased when compared to known arbiters.

In some embodiments, computing the grant vector comprises the steps of: (a) computing an intermediate vector by: inverting the binary request vector and summing the inverted request vector with the seed vector; or performing one or more equivalent logical operations on the binary request vector and the seed vector that produce the same output as inverting the binary request vector and summing the inverted request vector with the seed vector; and (b) producing the grant vector by: carrying out a bitwise XNOR operation on the binary request vector and the intermediate vector; or carrying out one or more equivalent logical operations on the binary request vector and the intermediate vector that produces the same output as carrying out a bitwise XNOR operation on the binary request vector and the intermediate vector. In this way, the grant vector can be computed using logic circuitry that is typically present on an FPGA. Furthermore, these steps are advantageous in that they result in increased clock speeds when compared with known arbiters.

In some embodiments, the one or more equivalent logical operations in step (b) comprises: inverting the binary request vector and performing a bitwise XOR operation on the inverted request vector and the intermediate vector.

Alternatively, the one or more equivalent logical operations in step (b) comprise: inverting the intermediate vector; and performing a bitwise XOR operation on the inverted intermediate vector and the binary request vector; or performing a bitwise XNOR operation on the inverted intermediate vector and the inverted request vector.

Preferably, the method further comprises, prior computing the intermediate vector: priming a first carry for computing the intermediate vector by: computing, based on the seed vector, a masked vector comprising n elements; computing a filtered vector by performing a bitwise OR operation on the inverted request vector and the masked vector; and performing a logical AND-reduction operation on the filtered vector to obtain a first carry value, wherein the first carry is primed with the first carry value. This sequence of operations may prevent the production of an invalid grant vector. Advantageously, the number of clock cycles required to arrive at a valid grant vector is reduced.

In some embodiments, the masked vector is computed by: obtaining an equivalent seed vector, wherein the equivalent seed vector is a one-hot binary vector comprising n+1 elements, the equivalent seed vector being equivalent to the seed vector; applying a left bitwise circular shift to the equivalent seed vector to obtain a left-shifted vector; and subtracting 1 from the left-shifted vector to obtain the masked vector. In this way, the masked vector can be computed using a sequence of logical operations present on an FPGA. Advantageously, the masked vector (and by extension, the first carry) are computed quickly.

In alternative embodiments, the masked vector is computed using a lookup table. In this way, fewer logical operations may be required to compute the masked vector.

Preferably, when the most significant bit (MSB) of the binary request vector and the MSB of the seed vector are both high, the first carry is primed as ‘0’. In this way, a further case in which an invalid grant vector is produced can be prevented. Advantageously, the number of clock cycles required to arrive at a valid grant vector is reduced.

Preferably, the method further comprises, prior to step (b): computing a modified intermediate vector by performing a bitwise OR operation on the inverted request vector and the intermediate vector; wherein the grant vector is produced at step (b) by: carrying out a bitwise XNOR operation on the inverted request vector and the modified intermediate vector; or carrying out one or more equivalent logical operations on the binary request vector and the modified intermediate vector that produces the same grant vector as carrying out the bitwise XNOR operation on the inverted request vector and the modified intermediate vector. In this way, a further case in which an invalid grant vector is produced can be prevented. Advantageously, the number of clock cycles required to arrive at a valid grant vector is reduced.

Preferably, the method further comprises: (c) computing a subsequent seed vector by applying a left bitwise circular shift to the grant vector; and repeating steps (a) to (b) using the subsequent seed vector as the seed vector. In this way, the method may be repeated using a seed vector that is different to the original seed vector, such that repetition of steps (a) to (b) results in a new grant vector that is different to the preceding grant vector. Advantageously, requests can be granted in a fairer manner, at least because the grant vector of subsequent iterations are guaranteed to be different to preceding iterations, such that a particular requesting node requesting resources is not granted the resources twice in a row.

In some embodiments, the method further comprises: repeating steps (a) to (c) using the subsequent seed vector as the seed vector until a stop condition is met. In this way, the method continues until the stop condition is met. Advantageously, the arbiter resources may be saved once the stop condition is met, because the method does not continue ad infinitum.

The stop condition may be that all of the plurality of requests have been provided with an indication of grant. In this way, the method continues until each of the requests have been granted. Advantageously, the method does not continue once all of the requests are granted, and fewer arbiter resources are wasted when there are no active requests.

The method may further comprise: updating, after computing the grant vector, the binary request vector based on the grant vector; and determining, based on the updated binary request vector, that all of the plurality of requests have been provided with an indication of grant. In this way, the stop condition can be determined using a sequence of logical operations that can be implemented using the FPGA. Advantageously, the stop condition can be obtained faster.

In some embodiments, obtaining a request size vector that indicates a number of requests associated with each requesting node in the plurality of nodes; wherein updating the binary request vector is further based on the request size vector.

Preferably, updating the binary request vector comprises changing a bit of the binary request vector corresponding to a requesting node to which the grant vector indicates grant.

In some embodiments, the method further comprises: determining that the grant vector is not a one-hot vector; and in response to determining that the grant vector is not a one-hot vector, computing the grant vector using a new seed vector, the new seed vector being a one-hot vector of length n. In this way, the methodology can account for situations in which an invalid grant vector is computed.

The high bit of the new seed vector may be determined by applying a left bitwise circular shift to the seed vector. In this way, the new seed vector is guaranteed to be different to the seed vector. Advantageously, the total number of clock cycles can be reduced, because there is no repetition of seed vectors that result in invalid grant vectors.

In some embodiments, generating the seed vector comprises: randomly generating a one-hot vector of length n. Advantageously, the logical circuitry required to generate the seed vector can be simplified.

In some embodiments, the method further comprises: receiving a request signal representative of the plurality of requests; wherein the binary request vector is obtained based on the request signal. The request signal may comprise one or more optical signals representative of the plurality of requests. In this way, the binary request vector may be more easily obtained based on optical signals.

In some embodiments, the method further comprises: allocating network resources based on the grant vector. In this way, the grant vector can be used to allocate resources to the requesting nodes requesting resources. Advantageously, in combination with the rest of the methodology, the network resources can be allocated more quickly than existing arbiters.

In accordance with a second aspect of the present disclosure, there is provided a network scheduling module for allocating network resources for communications between a plurality of nodes connected in a network, the module comprising a plurality of logic units and configured to carry out the steps of the first aspect.

In some embodiments, the network scheduling module is in communication with an optical receiving unit and the request signal comprises one or more optical signals representative of the plurality of requests.

The network scheduling module may be comprised in a field-programmable gate array (FPGA).

In accordance with a third aspect of the present disclosure, there is provided a data processing apparatus comprising a processor adapted to perform the steps of the method of the first aspect.

In accordance with a fourth aspect of the present disclosure, there is provided a computer-readable storage medium comprising instructions which, when executed by a computer, cause the computer to carry out the steps of the method of the first aspect.

In accordance with a fifth aspect of the present disclosure, there is provided network scheduling method for allocating network resources in a network comprising a plurality of nodes, the method comprising: obtaining a binary request vector representative of a plurality of requests for network resources, the binary request vector comprising n elements; generating a seed vector comprising n elements, the seed vector being a one hot binary vector indicating a requesting node that currently holds priority; computing an intermediate vector by inverting the binary request vector and combining the inverted binary request vector with the seed; and producing a grant vector by performing, between the binary request vector and the intermediate vector, an operation that yields a one hot grant vector providing an indication of grant to one of the requests represented in the binary request vector.

### BRIEF DESCRIPTION OF DRAWINGS

FIG. 1 schematically illustrates an example node for use in an optical circuit-switched network according to the present disclosure;

FIG. 2 schematically illustrates an example network interface card (NIC) for implementing the node of FIG. 1;

FIG. 3A schematically illustrates an example optical circuit-switched network;

FIG. 3B schematically illustrates an alternative representation of the network of FIG. 3A including a control plane;

FIG. 3C schematically illustrates a further alternative representation of the network of FIG. 3A including the control plane;

FIG. 4 schematically illustrates an example data scheduling unit;

FIG. 5A shows a flow diagram of a network scheduling method 500 for allocating network resources for communication between a plurality of nodes connected in a network, in accordance with an aspect of the present disclosure;

FIG. 5B shows a flow diagram of a method of computing a grant vector;

FIG. 6A shows a flow diagram of a method 600 for priming a first carry;

FIG. 6B shows an example implementation of the method of FIG. 6A; and

FIG. 7 shows a logical flow diagram of the method depicted in FIG. 5A.

### DETAILED DESCRIPTION

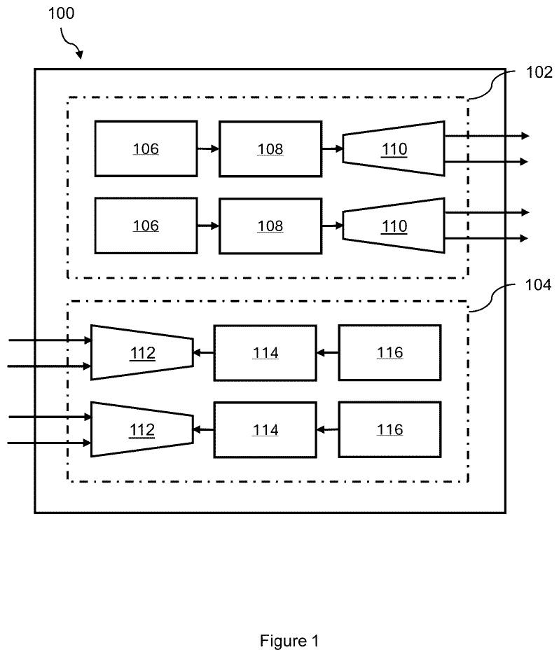

FIG. 1 schematically illustrates an example node 100 for use in an optical circuit-switched network according to the present disclosure. The node 100 is a physical or logical entity within the network at which data (in the form of light signals) can be processed, redirected, or terminated. For example, a node 100 could be associated with a data centre.

The node 100 may be thought of as having a transmit portion 102 and a receiver portion 104.

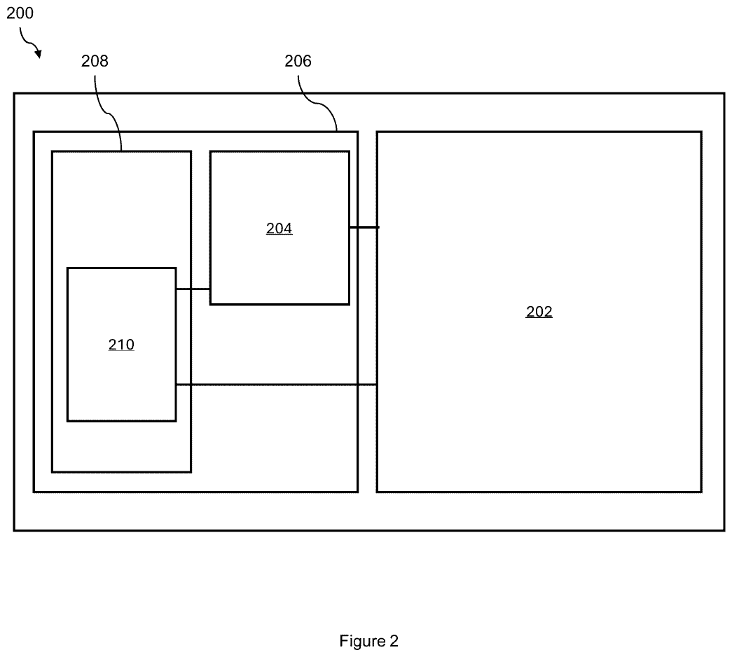

The transmit portion 102 comprises one or more (Y) independent transmit datapaths to support the connection of Y connection groups. Each transmit datapath is substantially similar, and they typically only differ by the connection group to which they can communicate, as will be discussed further below. Each transmit datapath in a node 100 comprises a wavelength-tuneable laser 106, a modulator 108, and a 1xX optical component 110. The laser 106 is typically a semiconductor laser 106 that can be tuned to very specific wavelengths (e.g., to a granularity of 36.8 nm) and preferably has a wavelength tuning time of less than 100 ns. The modulator 108 is configured to encode data onto light generated by the laser 106 to generate encoded light. The modulator 108 could be a 56 Gbaud PAM4 optical modulator 108 configured to adjust the amplitude of light output by the laser 106 to encode a symbol. The 1xX optical component 110 is an optical component comprising one input port and X output ports, such as an optical switch 110 or an optical splitter 110. The optical switch 110 is configured to receive the modulated light output by the modulator 108 and “steer” the modulated light such that it is output at one of the X output ports. Each output port is typically connected to another component, such as an output optical fibre (not shown). Whilst FIG. 2 illustrates 2 output ports per optical switch 110, this number is not limiting. The number (X) of output ports per optical switch 110 could be, for example, 8. Additionally, whilst FIG. 2 illustrates 2 optical switches 110, this number is not limiting. The number (Y) of optical switches 110 could be, for example 4.

The receiver portion 104 comprises one or more (Y) independent receive datapaths to support the connection of Y connection groups. Each receive datapath is substantially similar, and they typically only differ by the communication group to which they communicate, as will be discussed further below. The receive datapaths are independent of the transmit datapaths and are configured to communicate with a transmit datapath of a different node. Each receive datapath comprises an Xx1 optical component 112, a filter component 114, and a photodetection device 116. The Xx1 optical component 112 is an optical component comprising X input ports and one output port, such as an input switch 112. Each input port of the input switch 112 is configured to receive a respective optical signal, and the input switch 112 is configured to aggregate the optical signals into a single optical signal. The filter component 114 is configured to receive the optical signal output by the input switch 112 and isolate a desired wavelength or set of wavelengths. The photodetection device 116, such as a photodiode 116, is configured to receive the optical signal output by the filter component 114, and generates an electrical signal based on various properties of the received optical signal.

The elements of the transmit portion 102 and the receiver portion 104 are typically implemented as part of a photonic integrated circuit (PIC). The PIC is typically coupled to a network interface card (NIC) via a high-speed interconnect (e.g., an electrical interconnect). FIG. 2 illustrates a simplified systematic diagram of an example NIC 200. The NIC 200 comprises a field-programmable gate array

(FPGA) 202, a controller 204, a pluggable module 206, an optical engine 208, and a PIC 210. The FPGA 202 provides programmable logic that can be tailored to perform specific tasks in real time. The controller 204 is configured to provide control instructions to the FPGA 202 and the PIC 210. The pluggable module 206 comprises one or more optical components and their associated driver electronics and is configured to provide an installation platform for the optical engine 208. The optical engine 208 is a high-speed circuit board mounted on the pluggable module 206 and is configured to accommodate the PIC 210, along with other amplifier and driver devices. Finally, the PIC 210 includes the transmit portion 102 and receiver portion 104 and is configured to implement transmit and receive datapaths. The PIC 210 is in communication with the FPGA 202 and the controller 204, so that the controller can control the components of the transmit portion 102 and the receiver portion 104.

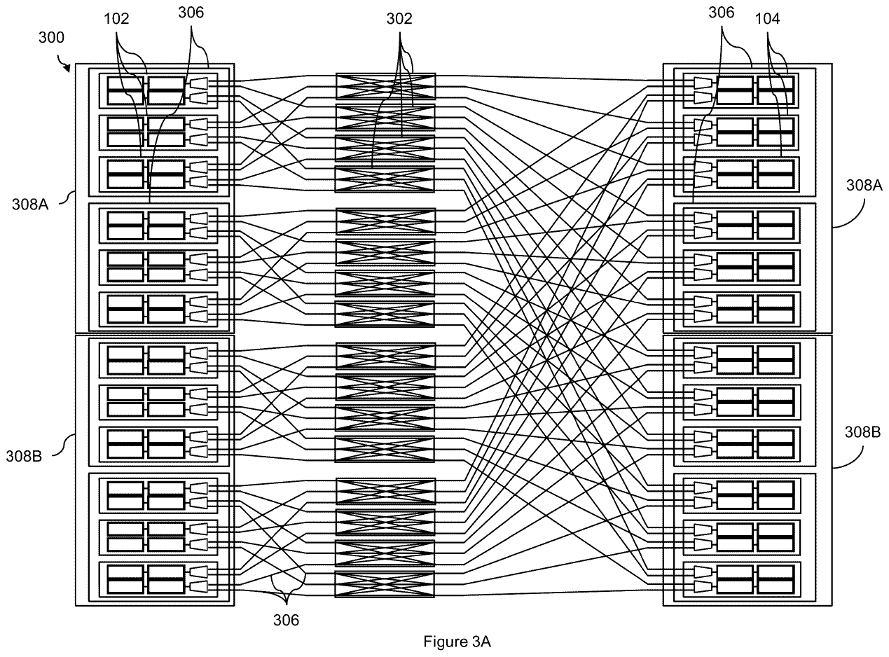

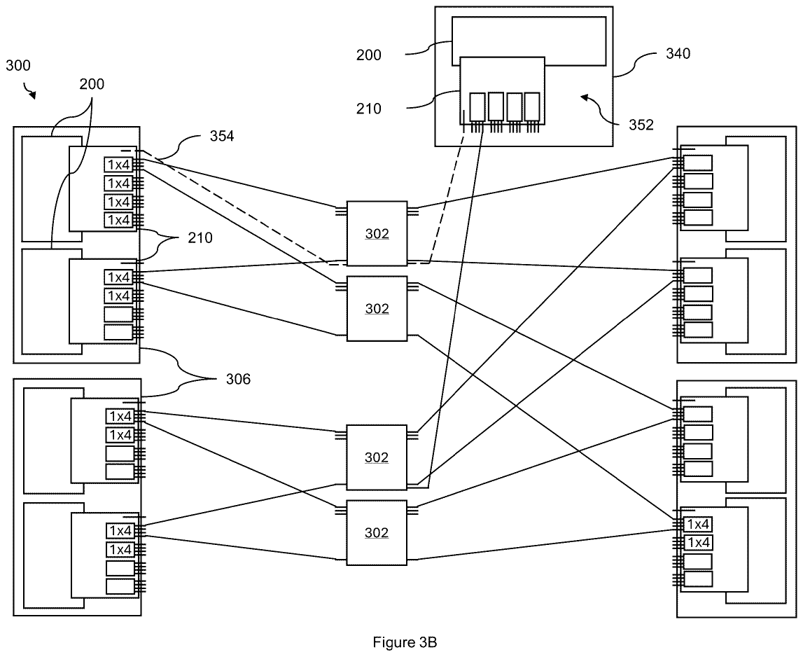

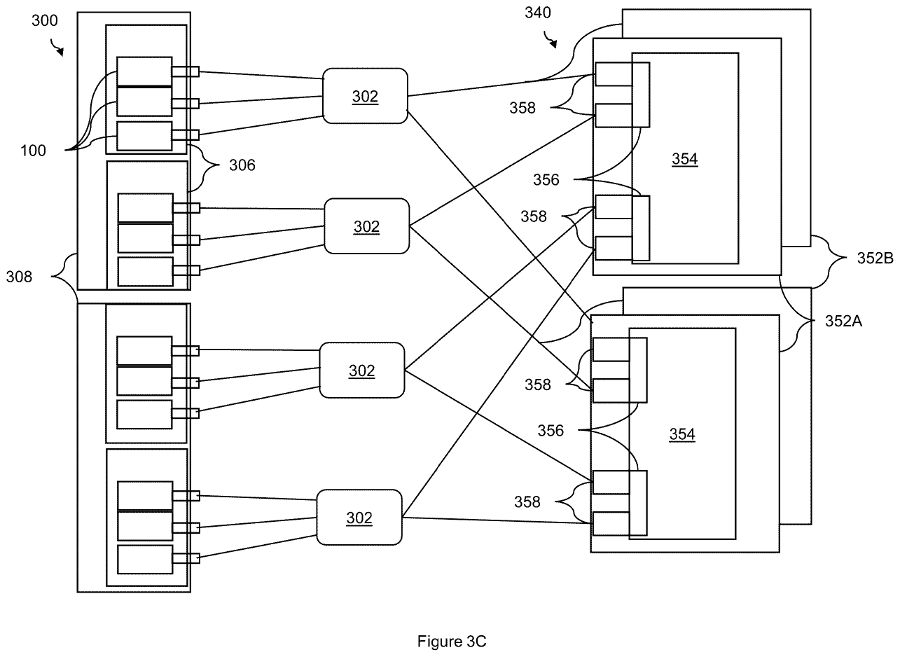

FIG. 3A schematically illustrates an example optical circuit-switched network 300. The optical circuit-switched network 300 comprises a plurality of nodes 100. For simplicity, the nodes 100 are split so that the transmit portions 102 are illustrated on the leftmost side, whilst the receiver portions 104 are illustrated on the rightmost side. As discussed above, each transmit portion 102 comprises a plurality of independent transmit datapaths, each comprising a laser 106, modulator 108, and switch 110. Encoded light from the transmit portion 102 is routed to the appropriate destination (i.e., receiver portion 104), based on the wavelength of the encoded light, using an arrayed waveguide router (AWGR) 302. The AWGR 302 is in communication with the transmit portions 102 and receiver portions 104 via optical fibres 304.

The nodes 100 are arranged into a plurality of racks 306, each rack comprising a number of nodes 100 equal to the number of wavelengths A supported by the AWGRs 302. For example, the number of wavelengths A supported by the AWGRs 302 could be in the range of 2 to 64 wavelengths. In the illustrated example, the number of wavelengths A supported by each AWGR 302 is 3 and therefore, the number of nodes in each rack 306 is 3. Each node 100 in a rack 306 is assigned a respective wavelength. In this way, encoded light from a source node in a rack 306 to a destination node in the rack 306 can be achieved by using the wavelength assigned to the destination node.

Since each node 100 comprises at least one optical switch 110, the encoded light can be steered to one of X output ports, each being associated with a respective AWGR 302. This provides scalability beyond a single rack 306, because each

AWGR 302 is associated with a different rack 306. For example, as shown in FIG. 3A, the upmost transmit portion 102 comprises an upper optical switch having two output ports. The upper output port is connected to an AWGR 302 that provides communication with the upper rack 306, whilst the lower output port is connected to an AWGR 302 that provides communication with the lower rack 306. The number of racks 306 that can be reached by a single optical switch 110 is equal to the number of output ports (X). To facilitate communication with these additional racks, X² AWGRs 302 are required.

To further scale the network 300, each node 100 comprises a plurality of (Y) transmit and receive datapaths. As discussed above, each transmit datapath of a transmit portion 102 of a node 100 comprises a laser 106, a modulator 108, and an optical switch 110. Each transmit datapath provides communication to a separate communication group 308, each communication group 308 comprising a plurality of racks 306. In the illustrated network 300, each node 100 comprises Y=2 datapaths, so that the network 300 comprises a first communication group 308A and a second communication group 308B. In the illustrated example, to communicate with the second communication group 308, a transmit portion 102 of a node 100 of the first communication group 308A utilises a transmit depicted as the lower transmit datapath. To facilitate communication between multiple communication groups 308, (XY)² AWGRs 302 are required, and 2Λ(XY)² optical fibres are required.

The number of nodes 100 supported by a network similar to the network 300 is ΛXY, because Y communication groups 308 can be supported, each communication group 308 having X racks 306, and each rack 306 having A nodes. As discussed above, the number of wavelengths Λ supported by each AWGR 302 can be up to 64 wavelengths, the number of racks X can up to 8, and the number of communication groups Y can be up to 4. Therefore, a maximum number of nodes in such a network can be up to 2048 nodes. Each transmit portion 102 of each node 100 of such a network 300 is in direct communication with each receiver portion 104 of each other node in the network 300. That is, each node 100 only requires passive optical components (e.g., AWGRs 302 and optical fibres 304) to communicate with other nodes 100.

FIG. 3B schematically illustrates an alternative representation of the network 300 including a control plane 340. In the illustration of FIG. 3B, the nodes are depicted as a NIC 200 including (or in communication with) a PIC 210, as discussed in relation to FIG. 2. The network 300 of FIG. 3B is a simplified drawing showing a single communication group 308 having a plurality of racks 306. Again, for simplicity, the nodes are split so that the transmit portions 102 are illustrated on the leftmost side, whilst the receiver portions 104 are illustrated on the rightmost side. For ease of illustration, only 4 AWGRs 302 are depicted. Each PIC 210 in the illustrated embodiment comprises 4 optical datapaths, each having a switch with 4 output ports.

The control plane 340 comprises one or more data scheduling units (DSUs) 352. The DSUs 352 are configured to coordinate connections between nodes 100 on the network 300 such that each destination node 100 never receives data from more than one source node 100 at the same time. The DSUs 352 are typically substantially similar in construction to the nodes 100 in the network 300 and comprise a NIC 200 including a PIC 210. Communication between the DSU 352 and the nodes 100 can be implemented in various ways. One example involves the use of a dedicated optical datapath 354 (shown as a dashed line in FIG. 3B) between each node 100 and the DSU 352. The optical datapath 354 can be implemented in the same way as the optical datapaths for communication between nodes 100, such that the optical datapath 354 includes a laser (not shown), a modulator (not shown), and an optical switch (not shown).

FIG. 3C schematically illustrates a further alternative representation of the network 300 including the control plane 340. In this illustration of FIG. 3C, two communication groups 308 are shown, although this number could be up to Y communication groups 308, depending on the number transmit datapaths on each node 100. Each of the communication groups is shown having two racks 306, although this number could be up to X, depending on the number of output ports for each optical switch of the nodes 100. Each rack is depicted as having three nodes, although this could be up to A, depending on the number of wavelengths supported by each AWGR 302. The control plane 340 includes N DSUs 352. There are two DSUs 352 depicted in FIG. 3C, but this could be up to A, depending on the number of wavelengths supported by each AWGR 302. It will be appreciated that if N=Λ, no AWGRs 302 are required.

The DSU 352 is similar to the node 200 of FIG. 2 and is typically implemented as a node in the network 300. The DSU 352 comprises a PIC 354 having Y optical datapaths 356. Each optical datapath include X output ports 358. The DSU 352 is configured to determine which nodes should be connected based on network traffic demands, prevent multiple nodes from attempting to use the same wavelength or optical path simultaneously, and allocate wavelengths and paths to the nodes.

In accordance with the present disclosure, each DSU 352 comprises a first DSU 352A and a second DSU 352B. The first DSU 352A is a primary DSU 352A that carries out most processing actions to coordinate connections between nodes. The second DSU 352B is a secondary DSU 352A that carries out the processing actions when the primary DSU 352A is unable to. Thus, the secondary DSU provides a level of redundancy.

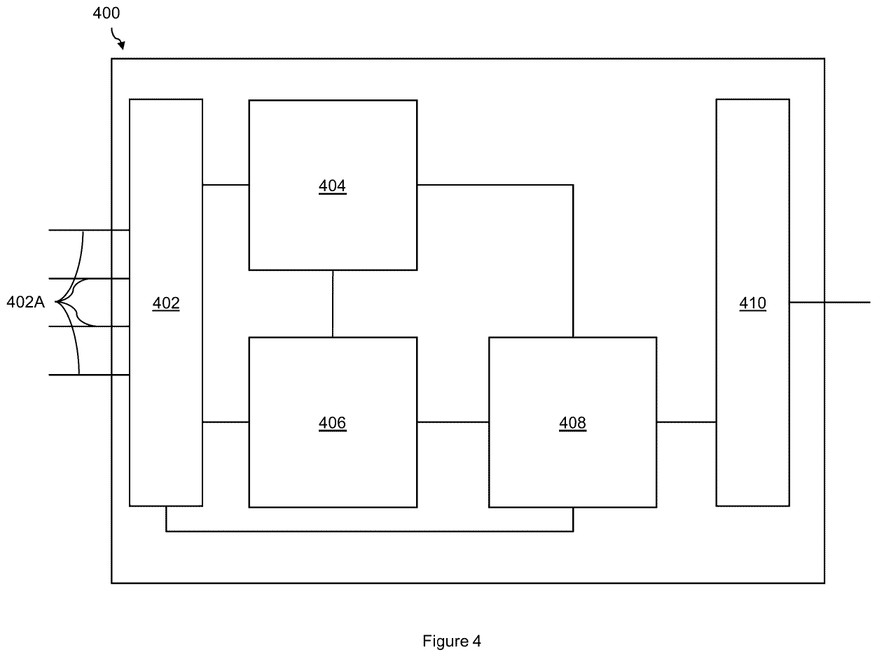

FIG. 4 illustrates an example data scheduling unit (DSU) 400. The DSU 400 comprises a request parser 402; an arbiter unit 404; a scheduler logic unit 406; a timing control unit 408; and a grant generator 410. It will be appreciated that this

DSU 400 is for illustrative purposes only, and that additional components may be present.

The request parser 402 is configured to temporarily store incoming requests for network resources from network nodes, such as the nodes 200 of the network 300 of FIG. 3B. The request parser 402 acts as a staging area to manage the incoming requests. The request parser 402 comprises a plurality of input buffers, each corresponding to a specific input port 402A or channel that receives a respective request from the nodes 200. For simplicity, in the illustrated example, the request parser 402 comprises four input ports 402A, each associated with a respective node 200 of the network 300. The nodes 200 in communication with the input ports 402A will herein be referred to as “node 1”, “node 2”, “node 3”, and “node 4”. In the present example, the request parser 402 is alternatively referred to as an optical receiving unit, because the input ports 402A communicate with the nodes 200 using optical signals. These optical signals are representative of requests from the nodes 200. It will be appreciated that this is by way of example only, and that the nodes may instead communicate with the request parser 402 using electrical signals.

The request parser 402 communicates with the arbiter unit 404, sending it the incoming requests (for example, in the form of a binary request vector, discussed further below) along with metadata (e.g., timestamps and/or requested resources) for scheduling decisions. The arbiter unit 404 accesses these buffers to determine which request for network resources should be prioritised or granted next.

The arbiter unit 404 is a network scheduling module configured to resolve contention by deciding which input buffers request is selected or prioritised next. The arbiter unit 404 implements a network scheduling method 500 according to the present disclosure (discussed further below) for allocating network resources for communication between a plurality of nodes connected in a network (e.g., the network 300). Once a decision is made (in the form of a grant vector), the arbiter unit 404 communicates with the scheduler logic unit 406, providing the grant vector, and optionally metadata about the prioritised request, including the originating (source) node and required resources. The arbiter unit 404 is critical for managing shared resources and enabling efficient scheduling.

The arbiter unit 404 is implemented as, or is comprised in, a Field-Programmable Gate Array (FPGA) (not shown) to enable high-speed, flexible, and reconfigurable decision-making for managing incoming requests in the DSU 400. The FPGA contains programmable logic units interconnected to form custom digital circuits that execute the network scheduling method 500. Each input port 402A of the DSU 400 is mapped to an input interface on the FPGA. These input interfaces are configured to receive a request signal representative of a plurality of requests for network resources, which the arbiter unit 404 uses to generate a binary request vector (discussed further below). For example, the input interfaces monitor request signals, including metadata such as priority level, timestamp, and resource requirements. As discussed above, the request signals may be optical signals representative of the plurality of requests.

The scheduler logic unit 406 works in conjunction with the arbiter unit 404 and receives the same signals from the request parser 402. The scheduler logic unit 406 processes the prioritised or granted request (according to the grant vector) and determines how resources will be allocated to fulfil the selected request. After receiving the arbiter unit's decision, the scheduler logic unit 406 coordinates with the timing control unit 408 to ensure the granted request is executed within specified time constraints. For example, if a request is for bandwidth or specific routing, the scheduler logic unit 406 determines the allocation plan. It communicates the scheduled plan and timing details to the grant generator 410 for final resource assignment or routing execution.

The timing control unit 408 is the master control block of the DSU 400, ensuring that all operations in the DSU 400 align with the system clock and time-sensitive constraints. The timing control unit 408 provides synchronisation signals to the scheduler logic unit 406, ensuring requests are executed in an orderly and timely manner. The timing control unit 408 also interacts with the grant generator 410 to ensure that scheduled actions, such as bandwidth allocation or routing, occur at the correct intervals. By coordinating timing across components, it ensures the DSU 400 fulfils requests within latency or timing requirements.

The grant generator 410 consolidates and executes the actions determined by the scheduler logic unit 406 (based on the grant vector produced by the arbiter unit 404). The grant generator 410 converts the scheduled requests into final commands for downstream components, such as routing configurations or resource allocations. For example, the grant generator 410 may assign bandwidth to a request, set up a routing path, or update a shared resource pool. It communicates with network interfaces or control systems to implement these actions.

An additional failure buffer (not shown) is included to store requests that do not pass initial processing. These requests are kept for potential retries in the future, ensuring that network resources are allocated efficiently without permanently discarding failed requests. The failure buffer improves system resilience by allowing temporarily unsuccessful requests to be reconsidered rather than dropped outright.

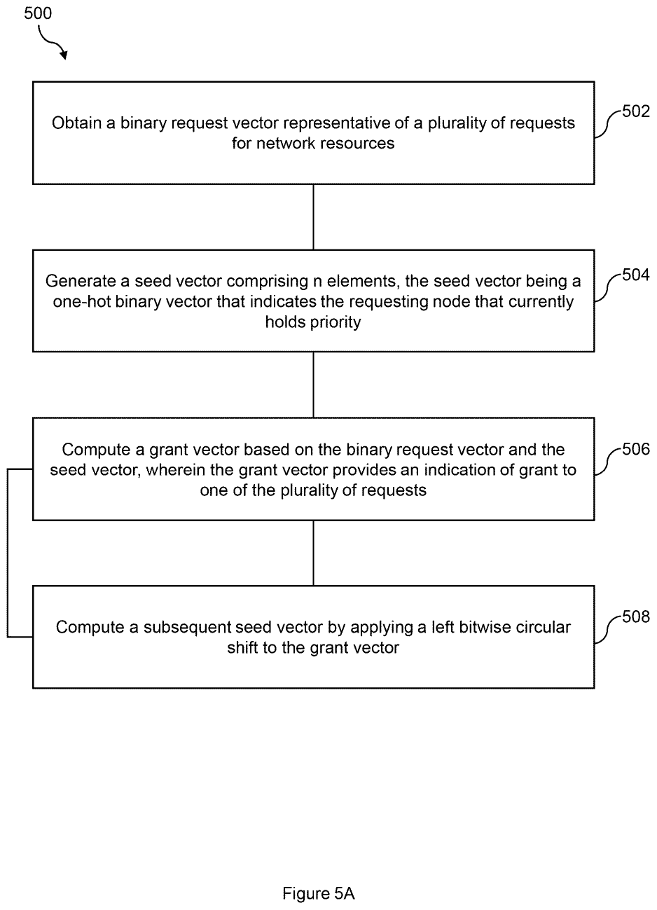

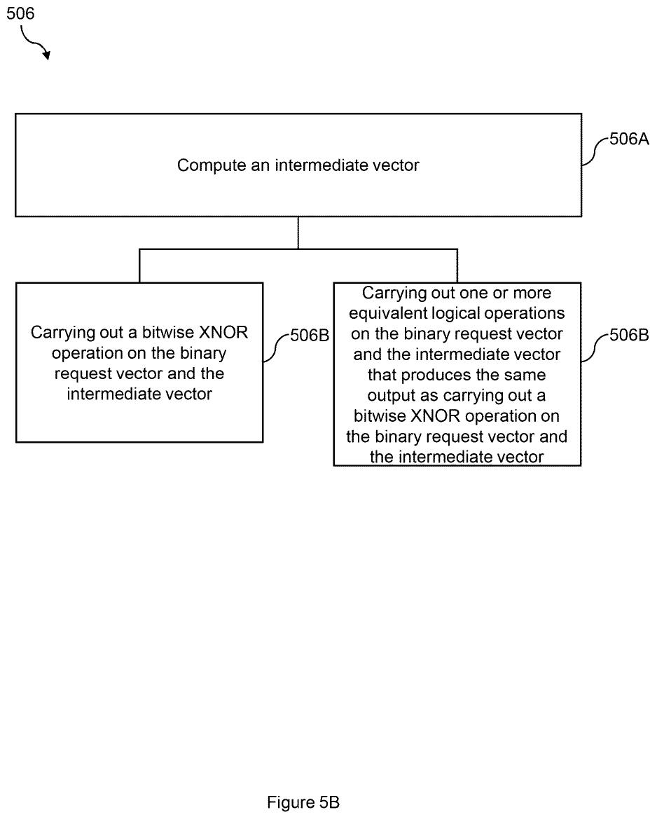

FIG. 5A illustrates a network scheduling method 500 for allocating network resources in a network comprising a plurality of nodes. The term “network resources” could mean any network resource associated with the network. A non-limiting list of examples incudes: an access to a destination node, a wavelength, a timeslot, a path and/or a virtual memory address. The network could be the network of FIGS. 3A to 3C. In such a network, the network scheduling method 500 is typically executed by the arbiter unit 404 of the DSU 400 and could be for allocating network resources for communication between the plurality of nodes 200 connected in the network 300. For example, the request for network resources could be a request from a source node (i.e., the requesting node) to access a destination node.

The following method steps refer to examples in which 4-bit vectors are used. However, it will be appreciated that this is not limiting, and that the n-bit vectors will typically comprise many more bits.

Step 502 of the method 500 comprises obtaining a binary request vector representative of a plurality of requests for network resources. Each request is from a requesting node of the plurality of nodes for a network resource. For example, each request is from a source node of the plurality of nodes for a network resource (such as a wavelength) to access a destination node of the plurality of nodes. The binary request vector comprising n elements, wherein n is the number of nodes in the plurality of requesting nodes.

The binary request vector may be generated by the request parser 402. Alternatively, the binary request vector is generated by the arbiter unit 404 upon receipt of a plurality of requests from the request parser 402.

In an illustrative example, the binary request vector is [1010]. This binary request vector is therefore representative of requests for network resources from nodes 1 and 3. The destination node (i.e., the node to which the source node requests connection) is not considered in the method 500.

Step 502 of the method 500 typically also comprises obtaining (e.g., generating or reviving) a request size vector that indicates a number of requests associated with each requesting node in the plurality of nodes. For example, node 1 may transmit 1 request for network resources, node 2 may transmit 0 requests for network resources, node 3 may transmit 3 requests for network resources, and node 4 may transmit 0 requests for network resources. In this example, the request size vector would be [1030].

Step 504 of the method 500 comprises generating a seed vector comprising n elements, the seed vector being a one-hot binary vector that indicates the requesting node that currently holds priority. That is, the requesting node that corresponds to the hot bit in the one-hot binary seed vector is considered to be the requesting node that currently holds priority. One way to generate the seed vector is to randomly generate a one-hot vector of length n. For example, continuing with the illustrative example, a seed vector may be randomly generated as [0010]. In this example, the requesting node that corresponds to the hot bit is node 3.

Step 506 of the method 500 comprises computing a grant vector based on the binary request vector and the seed vector. The grant vector provides an indication of grant to one of the plurality of requests. FIG. 5B shows a flow diagram of a method 506 of computing a grant vector.

Step 506A of the method 506 comprises computing an intermediate request vector. This step can be achieved in several ways using logical circuitry typically found in an FPGA, or using one or more look-up tables (LUTs) configured to implement combinational logic. In implementations using LUTs, an additional LUT or FPGA resource is required to provide a carry chain to generate and propagate carry-out values for each bit-wise operation. In the following example, each bitwise XNOR or XOR operation also utilises this carry chain.

The intermediate vector could be computed by inverting the binary request vector and summing the inverted request vector with the seed vector. This can be achieved using logical circuitry typically found in an FPGA. Continuing with the illustrative embodiment, the binary request vector [1010] is inverted to the inverted request vector [0101]. The inverted request vector [0101] is summed with the seed vector [0010] to compute the intermediate vector [0111].

Alternatively, the intermediate vector is computed by performing one or more equivalent logical operations on the binary request vector and the seed vector that produce the same output as inverting the binary request vector and summing the inverted request vector with the seed vector.

For example, the one or more equivalent logical operations comprises: inverting the binary request vector and carrying out a bitwise XOR operation on the inverted request vector and the seed vector. Continuing with the illustrative embodiment, the binary request vector [1010] is inverted to the inverted request vector [0101], and carrying out the bitwise XOR operation on the inverted request vector [0101] and the seed vector [0010] produces the intermediate vector [0111].

In a further example, the one or more equivalent logical operations comprises: computing an inverted request vector by inverting the binary request vector; computing an inverted seed vector by inverting the seed vector and performing a bitwise XNOR operation on the inverted seed vector and the inverted request vector. Continuing with the illustrative embodiment, the binary request vector [1010] is inverted to the inverted request vector [0101], the seed vector [0010] is inverted to the inverted seed vector [1101], and performing the bitwise XNOR operation on the inverted request vector [0101] and the inverted seed vector [1101] produces the intermediate vector [0111].

In a further example, the one or more equivalent logical operations comprises: performing a bitwise XNOR operation on the seed vector and the request vector. Continuing with the illustrative embodiment, performing the bitwise XNOR operation on the request vector [1010] and the seed vector [0010] produces the intermediate vector [0111].

In a further example, the one or more equivalent logical operations comprises: computing an inverted seed vector by inverting the seed vector, and performing a bitwise XOR operation on the binary request vector and the inverted seed vector. Continuing with the illustrative embodiment, the seed vector [0010] is inverted to the inverted seed vector [1101], and performing the bitwise XOR operation on the binary request vector [1010] and the inverted seed vector [1101] produces the intermediate vector [0111].

Thus, it can be seen that there are several ways to arrive at the same intermediate vector.

Step 506B comprises producing the grant vector. This can be achieved in several ways using logical circuitry typically found in an FPGA.

In a first implementation, producing the grant vector is achieved by: carrying out a bitwise XNOR operation on the binary request vector and the intermediate vector. Continuing with the illustrative embodiment, performing a bitwise XNOR operation on the binary request vector [1010] and the intermediate vector [0111] results in the grant vector [0010].

The same grant vector can be obtained by carrying out one or more equivalent logical operations on the binary request vector and the intermediate vector that produces the same output as carrying out a bitwise XNOR operation on the binary request vector and the intermediate vector.

In an alternative implementation, carrying out one or more equivalent operations comprises inverting the binary request vector and performing a bitwise XOR operation on the inverted request vector and the intermediate vector. Continuing with the illustrative embodiment, performing a bitwise XOR operation on the inverted request vector [0101] and the intermediate vector [0111] results in the grant vector [0010].

In a further alternative implementation, carrying out one or more equivalent operations comprises computing an inverted intermediate vector by inverting the intermediate vector and performing a bitwise XNOR operation on the inverted intermediate vector and the inverted request vector. Continuing with the illustrative embodiment, inverting the intermediate vector [0111] results in an inverted intermediate vector [1000], and performing a bitwise XNOR operation on the inverted intermediate vector [1000] and the inverted request vector [0101] results in the grant vector [0010].

In a further alternative implementation, carrying out one or more equivalent operations comprises computing an inverted intermediate vector by inverting the intermediate vector and performing a bitwise XOR operation on the inverted intermediate vector and the binary request vector. Continuing with the illustrative embodiment, inverting the intermediate vector [0111] results in an inverted intermediate vector [1000], and performing a bitwise XOR operation on the inverted intermediate vector [1000] and the binary request vector [1010] results in the grant vector [0010]. Therefore, the same grant vector can be produced using different logical operations.

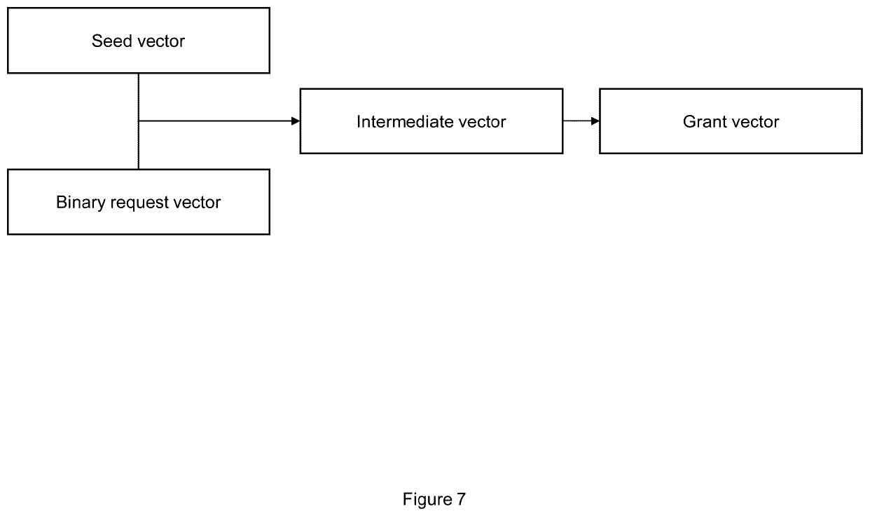

FIG. 7 shows a logical flow diagram illustrating the outputs of the steps of the method 500. As shown in FIG. 7, the seed vector and the binary request vector are used to compute an intermediate vector, which is in turn used to compute the grant vector.

Steps 502 to 506 of the method 500 result in a grant vector that provides an indication of grant to one of the plurality of requests by outputting a grant vector that is a one-hot vector. The hot bit of the one-hot grant vector provides the indication of grant for the appropriate request (or requesting node). In the illustrative embodiment, the grant vector of [0010] provides an indication of grant to the request of from node 3.

However, there will typically be a plurality of requests from requesting nodes for network resources (e.g., to access destination nodes). To grant the other requests, the method 500 further comprises step 508, which includes computing a subsequent seed vector by applying a left bitwise circular shift to the grant vector. In particular, the hot bit of the grant vector is shifted to the left. If the hot bit is the most-significant bit, the left bitwise circular shift leads to the least-significant bit being the hot vector. Step 506 (according to the first embodiment or the second embodiment) is repeated using the subsequent seed vector as the seed vector.

Continuing with the illustrative example, applying a left bitwise circular shift to the grant vector [0010] results in a subsequent seed vector of [0100]. Therefore, step 506 is repeated using the subsequent seed vector [0100].

Steps 502 to 508 are repeated until a stop condition is met.

The stop condition could be that all of the plurality of requests have been provided with an indication of grant, such that there are no longer any active requests to grant. For example, when the grant vector is computed, the binary request vector can be updated based on the grant vector.

As discussed above, the method can further include the step of obtaining a request size vector that indicates a number of requests associated with each requesting node in the plurality of nodes. Updating the binary request vector is further based on the request size vector. In particular, the request size vector can be updated. For example, the grant vector can be subtracted from the request size vector. Continuing with the present example in which the request size vector is [1030] and the grant vector is [0010], subtracting the grant vector from the request size vector produces a new request size vector of [1020]. When a node's entry in the request size vector becomes 0, the binary request vector is updated to reflect that there are no more active requests from that node. For example, an iteration with a binary request vector of [1010], size vector of [1030], and grant vector [1000] results in a new request size vector of [0030]. The binary request vector is updated to [0010] to reflect that there are no more active requests from node 1.

Alternatively, the method comprises updating the binary request vector by subtracting the grant vector from the binary request vector. For example, when a grant vector [1000] is produced, the binary request vector [1111] is updated to [0111].

In both of the above examples, updating the binary request vector comprises changing a bit of the binary request vector corresponding to a requesting node to which the grant vector indicates grant.

The stop condition can be implemented by determining, prior to computing the intermediate vector or after updated the binary request vector is updated, that there are no active requests. For example, the method 500 may comprise performing a logical OR-reduction operation on the binary request vector to produce an active request flag. If the binary request flag is ‘1’, the method 500 continues, else the method 500 stops. The binary request flag will be ‘1’ as long as there is a single active request.

An advantage of the method 500 is that the grant vector can be computed in each iteration using a sequence of logic gates and particularly using an adder. In particular, the critical path of decision making is on the adder, which tends to be faster than existing methods. Conventional arbitration methods use a binary tree-based or carry-chain based grant computation, which results in increased logic levels (number of gates between two flip-flops) with scale, especially when it comes to implementation on an FPGA. Since FPGA configurable logic blocks are designed for easy implementation of half or full adders with carry blocks, the method 500 takes advantage of this architecture. Consequently, the reduced logic levels with this adder-based arbiter increases clock speeds, enabling grants to be issued more quickly.

Steps 502 to 508 provide a valid output grant vector (i.e., a grant vector that is a one-hot binary vector) only when the seed vector has a high bit corresponding to a requesting node that is actively requesting network resources (e.g., to access a destination node). For example, in the prior illustrative example, the binary request vector is [1010], the seed vector is [0010], and a grant vector [0010] is produced. Therefore, the high bit of the seed vector corresponds to the third node, which happens to have an active request for network resources to access a destination node, as indicated by the binary request vector.

In a different example, the binary request vector is [1010], and the seed vector is [0001]. Following step 506 of the method 500, summing the inverted request vector [0101] with the seed vector [0001] produces an intermediate vector [0110]. In step 506B (using the first implementation), carrying out a bitwise XNOR operation on the binary request vector [1010] and the intermediate vector [0110] produces a grant vector of [0011]. This grant vector is not a valid grant vector, because it indicates grant to more than one requesting node in a single iteration.

To account for occurrences of an invalid grant vector, the method may further comprise determining that the grant vector is not a one-hot grant vector. The FPGA logic circuitry can be designed so as to carry out this determination. For example, the FPGA logic circuitry may utilise an adder tree to compute the sum of all bits of the grant vector and use comparison logic to determine that the sum is not equal to 1 (thereby indicating that the grant vector is not a one-hot vector).

In response to determining that the grant vector is not a one-hot vector (e.g., based on the output of the comparison logic), step 506 (computing the grant vector) is repeated using a new seed vector, the new seed vector being a one-hot vector of length n. It is preferable that the new seed vector is different to the prior seed vector to avoid wasting clock cycles of the FPGA. For example, continuing with the prior example in which the seed vector of [0001] results in an invalid grant vector, the new seed vector is selected such that it is not [0001]. For example, the new seed vector is determined by applying a left bitwise circular shift to the seed vector. In this way, the new seed vector is guaranteed to differ from the seed vector. This process of determining that the grant vector is not a one-hot vector and repeating step 506 using a new seed vector can be repeated until a valid grant vector is obtained at step 506, in which case the method proceeds to step 508.

An alternative way to account for the occurrences of an invalid grant vector is to use the logic circuitry to automatically account for and prevent the production of an invalid grant vector. That is, logic circuitry can be used to avoid an invalid grant vector ever being produced.

The extra steps carried out to avoid the invalid grant vector occur prior to step 506B. That is, these steps occur before the grant vector is produced.

A first step comprises computing a modified intermediate vector by performing a bitwise OR operation on the inverted request vector and the intermediate vector. Continuing with the above invalid grant vector example, the binary request vector is [1010], the seed vector is [0001], the inverted request vector is [0101], and the intermediate vector is [0110]. Performing a bitwise OR operation on the inverted request vector [0101] and the intermediate vector [0110] produces the modified intermediate vector of [0111].

This modified intermediate vector is used in place of the intermediate vector to produce a grant vector in step 506B by carrying out a bitwise XNOR operation on the binary request vector and the modified intermediate vector. Similar to the discussion around step 506B, the same grant vector can be obtained by carrying out one or more equivalent logical operations on the request vector and the filtered vector that produces the same output as carrying out a bitwise XNOR operation on the inverted request vector and the modified intermediate vector.

Continuing with this invalid grant vector example, the binary request vector is [1010] and the filtered vector is [0111]. Performing a bitwise XNOR operation on the binary request vector [1010] and the filtered vector [0111] results in a grant vector of [0010].

Therefore, a valid grant vector is produced, even in situations that would otherwise lead to the production of an invalid grant vector. Advantageously, the grant vector is more reliably produced, and the number of clock cycles required to arrive at the valid grant vector is reduced in situations that would otherwise result in an invalid grant vector.

In an FPGA, logic may be built using Lookup Tables (LUTs) that can implement basic logic functions. However, when it comes to adding operations, each bit's result depends on a carry from the previous bit. Normally, sending this carry signal from one LUT to the next would slow things down because of the time it takes for signals to travel between them. However, in an FPGA, a carry chain solves this by providing a dedicated, direct path for the carry signals to flow between adjacent bits, bypassing the slower general-purpose routing. This dedicated path is physically wired on the chip, making the carry operation extremely fast.

In some situations, following the method 500 produces an invalid grant vector as a result of overflow. These situations typically occur when the seed vector is greater than the binary request vector, which causes a faulty overflow in the summing operation that results in an invalid grant vector. To illustrate this, a binary request vector [0010] and a seed vector [1000] will be considered. The inverse request vector is [1101]. It can be seen that summing the seed vector [1000] and the inverse request vector [1101] would cause an overflow of the 4-bit intermediate vector that would not produce a valid grant vector. In particular, summed vector [10101] would be produced, and the intermediate vector would be [0101]. The grant vector is obtained by carrying out a bitwise XNOR operation on the binary request vector [0010] and the intermediate vector [0101] to produce a grant vector of [1000]. In this case, the grant vector is invalid because it provides an indication of grant to a node that has no active request.

To account for the faulty overflow, prior to computing the intermediate vector (e.g., prior to summing the inverse request vector and the seed vector), the method 500 further includes priming (or setting) a first carry for computing the intermediate vector (e.g., for summing the inverse request vector and the seed vector). The first carry refers to the carry value in the carry chain that is used during addition or summing of the first bit. Typically, when a half adder or full adder is used in a binary summing operation, there is no carry (or a carry of “0”) for the first bit. The proposed method addresses the overflow problem by priming the first carry to be “1” under certain conditions. The term “priming” may be understood as an operation for setting a carry value to either a “0” or a “1”.

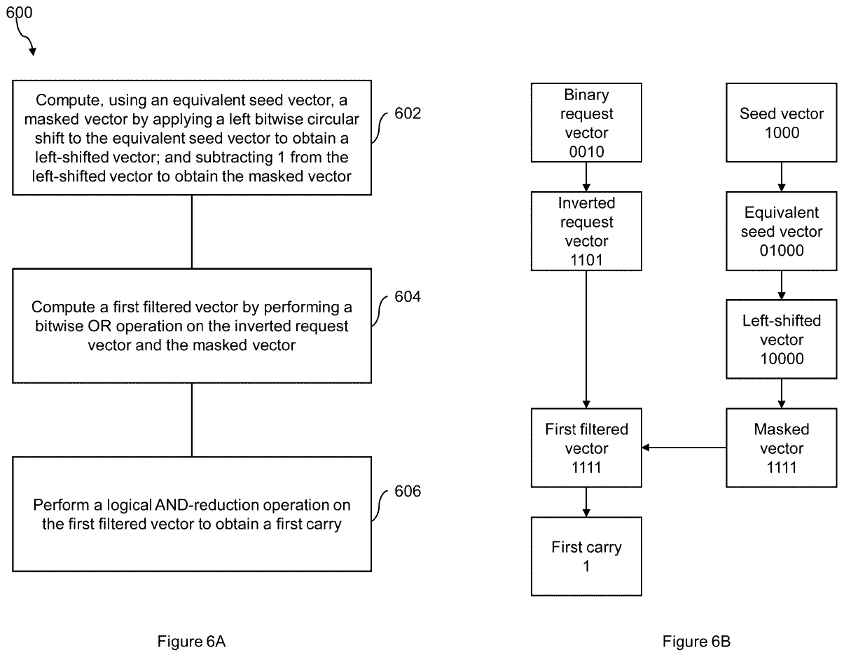

FIG. 6A illustrates a flow diagram of a method 600 for priming a first carry. This method 600 can be implemented using FPGA logic circuitry. In the method 600, an “equivalent seed vector” is used. The equivalent seed vector is a one-hot binary vector comprising n+1 elements, The equivalent seed vector is equivalent to the seed vector. In other words, the equivalent seed vector is numerically equivalent to the seed vector. The equivalent seed vector could also be considered as a left-padded version of the seed vector. For example, an equivalent seed vector [00010] is equivalent to a seed vector [0010].

FIG. 6B illustrates an example implementation of the method 600 using a binary request vector [0010] and a seed vector [1000] will be considered. The inverse request vector is [1101]. In this example, the equivalent seed vector is [01000].

Step 602 comprises computing a masked vector based on the seed vector.

In one implementation, the masked vector is computed by: applying a left bitwise circular shift to the equivalent seed vector to obtain a left-shifted vector, and subtracting 1 from the left-shifted vector to obtain the masked vector. The masked vector comprises n elements. These n elements are the first n elements of the vector produced after subtracting 1 from the left-shifted vector. Continuing with this example applying a left bitwise circular shift to the equivalent seed vector [01000] produces a left-shifted vector of [10000]. Subtracting 1 from the left-shifted vector produces vector [01111], and thus the masked vector is [1111].

In an alternative implementation, the masked vector is computed using a lookup table. An example LUT is:

| Seed vector | Masked vector |
|---|---|
| [0001] | [0001] |
| [0010] | [0011] |
| [0100] | [0111] |
| [1000] | [1111] |

Step 604 comprises computing a filtered vector by performing a bitwise OR operation on the inverted request vector and the masked vector. Continuing with this example, performing a bitwise OR operation on the inverted request vector [1101] and the masked vector [1111] produces a filtered vector of [1111].

Step 606 comprises performing a logical AND-reduction operation on the filtered vector to obtain the first carry. Continuing with this example, performing a logical AND-reduction operation on the filtered vector [1111] produces a first carry of 1.

This first carry is used to obtain the intermediate vector. In particular, the first carry is used as the first carry value in the carry chain for summing the intermediate vector and the seed vector. Alternatively, if a LUT is used for computing the intermediate vector, the first carry is used as the first carry value in the carry chain for the bitwise XOR or XNOR operation.

Continuing with this example, summing the inverse request vector [1101] and the seed vector [1000] to obtain the intermediate vector using the first carry is as follows. For the first bit of the intermediate vector, the first bit ‘1’ of the inverse request vector is summed with first bit ‘0’ of the seed vector, and the first carry ‘1’, to produce ‘1’ with a second carry of ‘1’. For the second bit of the intermediate vector, the second bit ‘0’ of the inverse request vector is summed with the second bit ‘0’ of the seed vector, and the second carry ‘1’ to produce ‘1’ with no carry. For the third bit of the intermediate vector, the third bit ‘1’ of the inverse request vector is summed with the third bit ‘0’ of the seed vector, and the third carry ‘0’ to produce ‘1’ with no carry. Finally, for the fourth bit of the intermediate vector, the fourth bit ‘1’ of the inverse request vector is summed with the fourth bit ‘1’ of the seed vector, and the third carry ‘0’ to produce ‘0’ with a fourth carry of ‘1’. Therefore, an intermediate vector [0110] is produced.

The grant vector is obtained by carrying out a bitwise XNOR operation on the binary request vector [0010] and the intermediate vector [0110] to produce a grant vector of [0010]. Therefore, the method 600 facilitates production of a valid grant vector that provides an indication of grant to a requesting node.

In some cases of the method 600, the most significant bit (MSB) of the binary request vector and the MSB of the seed vector are both high values, which results in a “faulty” carry resulting in an invalid grant vector. For example, a binary request vector [1101] (inverse request vector [0010]) and a seed vector [1000] (equivalent seed vector [01000]) produce a faulty carry. At step 602, masked vector [1111] is produced. At step 604, filtered vector [1111] is produced. At step 606, first carry ‘1’ is obtained. Summing the inverse request vector [0010] and seed vector [1000] using this first carry ‘1’ produces an intermediate vector [1011]. Carrying out a bitwise XNOR operation on the binary request vector [1101] and the intermediate vector [1011] produces a grant vector of [1001]. Since this is not a one-hot vector, this grant vector is not valid.

To account for this faulty carry situation, when the MSB of the binary request vector and the MSB of the seed vector are both high (i.e., both ‘1’), the first carry is primed or set as ‘0’, and the steps of the method 600 are not carried out. In other words, if the MSB of the binary request vector and the MSB of the seed vector are both high, the first carry is set to ‘0’, else the method 600 is performed. Continuing with this example, summing the inverse request vector [0010] and seed vector [1000] using this first carry ‘0’ produces an intermediate vector [1010]. Carrying out a bitwise XNOR operation on the binary request vector [1101] and the intermediate vector [1010] produces a grant vector of [1000]. This is a valid grant vector because it is a one-hot vector that provides an indication of grant to one of the requesting nodes.

One or more of the above methods for accounting for (i.e., preventing) the occurrence of an invalid grant vector can be combined.

For example, a complete network scheduling method may comprise:
obtaining a binary request vector representative of a plurality of requests for network resources, each request being from a requesting node of the plurality of nodes for a network resource, the binary request vector comprising n elements, wherein n is the number of requesting nodes in the plurality of nodes;
generating a seed vector comprising n elements, the seed vector being a one-hot binary vector that indicates the requesting node that currently holds priority;
(a) priming a first carry by: computing, based on the seed vector, a masked vector comprising n elements; computing a filtered vector by performing a bitwise OR operation on the inverted request vector and the masked vector; and performing a logical AND-reduction operation on the filtered vector to obtain a first carry value, wherein the first carry is primed with the first carry value;
computing an intermediate vector by: inverting the binary request vector and summing the inverted request vector with the seed vector using the first carry; or performing one or more equivalent logical operations on the binary request vector and the seed vector using the first carry that produce the same output as inverting the binary request vector and summing the inverted request vector with the seed vector;
computing a modified intermediate vector by performing a bitwise OR operation on the inverted request vector and the intermediate vector;
(b) producing a grant vector by: carrying out a bitwise XNOR operation on the inverted request vector and the modified intermediate vector; or carrying out one or more equivalent logical operations on the binary request vector and the modified intermediate vector that produces the same grant vector as carrying out the bitwise XNOR operation on the inverted request vector and the modified intermediate vector; and
(c) computing a subsequent seed vector by applying a left bitwise circular shift to the grant vector; and repeating steps (a) to (b) using the subsequent seed vector as the seed vector until a stop condition is met.

1. A network scheduling method for allocating network resources in a network comprising a plurality of nodes, the method comprising:
obtaining a binary request vector representative of a plurality of requests for network resources, each request being from a requesting node of the plurality of nodes for a network resource, the binary request vector comprising n elements, wherein n is the number of requesting nodes in the plurality of nodes;
generating a seed vector comprising n elements, the seed vector being a one-hot binary vector that indicates the requesting node that currently holds priority; and
computing a grant vector based on the binary request vector and the seed vector, wherein the grant vector provides an indication of grant to one of the plurality of requests;
wherein computing the grant vector comprises the steps of:
(a) computing an intermediate vector by:
inverting the binary request vector and summing the inverted request vector with the seed vector; or
performing one or more equivalent logical operations on the binary request vector and the seed vector that produce the same output as inverting the binary request vector and summing the inverted request vector with the seed vector; and
(b) producing the grant vector by:
carrying out a bitwise XNOR operation on the binary request vector and the intermediate vector; or
carrying out one or more equivalent logical operations on the binary request vector and the intermediate vector that produces the same output as carrying out a bitwise XNOR operation on the binary request vector and the intermediate vector.

2. The method of claim 1, further comprising, prior to computing the intermediate vector:
priming a first carry for computing the intermediate vector by:
computing, based on the seed vector, a masked vector comprising n elements;
computing a filtered vector by performing a bitwise OR operation on the inverted request vector and the masked vector; and
performing a logical AND-reduction operation on the filtered vector to obtain a first carry value, wherein the first carry is primed with the first carry value.

3. The method of claim 2, wherein the masked vector is computed by:
obtaining an equivalent seed vector, wherein the equivalent seed vector is a one-hot binary vector comprising n+1 elements, the equivalent seed vector being equivalent to the seed vector;
applying a left bitwise circular shift to the equivalent seed vector to obtain a left-shifted vector; and
subtracting 1 from the left-shifted vector to obtain the masked vector.

4. The method of claim 2, wherein the masked vector is computed using a lookup table.

5. The method of claim 2, wherein when the most significant bit (MSB) of the binary request vector and the MSB of the seed vector are both high, the first carry is primed as ‘0’.

6. The method of claim 1, further comprising, prior to step (b):
computing a modified intermediate vector by performing a bitwise OR operation on the inverted request vector and the intermediate vector;
wherein the grant vector is produced at step (b) by:
carrying out a bitwise XNOR operation on the inverted request vector and the modified intermediate vector; or
carrying out one or more equivalent logical operations on the binary request vector and the modified intermediate vector that produces the same grant vector as carrying out the bitwise XNOR operation on the inverted request vector and the modified intermediate vector.

7. The method of claim 1, further comprising:
(c) computing a subsequent seed vector by applying a left bitwise circular shift to the grant vector; and
repeating steps (a) to (b) using the subsequent seed vector as the seed vector.

8. The method of claim 7, further comprising:
repeating steps (a) to (c) using the subsequent seed vector as the seed vector until a stop condition is met.

9. The method of claim 8, wherein the stop condition is that all of the plurality of requests have been provided with an indication of grant; and optionally, further comprising:
updating, after computing the grant vector, the binary request vector based on the grant vector; and
determining, based on the updated binary request vector, that all of the plurality of requests have been provided with an indication of grant.

10. The method of claim 9, further comprising:
obtaining a request size vector that indicates a number of requests associated with each requesting node in the plurality of nodes;
wherein updating the binary request vector is further based on the request size vector.

11. The method of claim 9, wherein updating the binary request vector comprises changing a bit of the binary request vector corresponding to a requesting node to which the grant vector indicates grant.

12. The method of claim 1, further comprising:
determining that the grant vector is not a one-hot vector; and
in response to determining that the grant vector is not a one-hot vector, computing the grant vector using a new seed vector, the new seed vector being a one-hot vector of length n; and
optionally wherein the high bit of the new seed vector is determined by applying a left bitwise circular shift to the seed vector.

13. A network scheduling module for allocating network resources for communications between a plurality of nodes connected in a network, the module comprising a plurality of logic units and configured to carry out the steps of claim 1.

14. A computer-readable storage medium comprising instructions which, when executed by a computer, cause the computer to carry out the steps of the method of claim 1.

15. A network scheduling method for allocating network resources in a network comprising a plurality of nodes, the method comprising:
obtaining a binary request vector representative of a plurality of requests for network resources, the binary request vector comprising n elements;
generating a seed vector comprising n elements, the seed vector being a one hot binary vector indicating a requesting node that currently holds priority;
computing an intermediate vector by inverting the binary request vector and combining the inverted binary request vector with the seed; and
producing a grant vector by performing, between the binary request vector and the intermediate vector, an operation that yields a one hot grant vector providing an indication of grant to one of the requests represented in the binary request vector.
